(19) United States
(12) Patent Application Publication
(10) Pub. No.: US 2022/0089365 A1
(43) Pub. Date: Mar. 24, 2022

(54) TRASH CAN SYSTEM

(71) Applicant: Matthew M. Wasemiller, Temecula, CA (US)

(72) Inventor: Matthew M. Wasemiller, Temecula, CA (US)

(21) Appl. No.: 17/031,117

(22) Filed: Sep. 24, 2020

(51) Int. Cl. B65F 1/14; B65D 21/08

(52) U.S. Cl. CPC B65F 1/1426; B65F 2220/1066; B65D 21/086

(57) ABSTRACT

Embodiments disclosed herein relate to a cylinder system for storing and disposing of items/trash. The system can include a first cylinder configured to move in a vertical direction with an adjustable height and fixed diameter. The system may also include a second cylinder configured with an adjustable height and fixed diameter, wherein the second cylinder is configured with the diameter less than the diameter of the first cylinder to enable the second cylinder to be positioned within the first cylinder. In addition, the system may include one or more cushioned pads that encircle an exterior portion of the second diameter of the second cylinder, wherein the one or more cushioned pads enable the first cylinder to glide vertically along the exterior portion of the second cylinder. Further, the system can include a ring endcap configured on the second cylinder, wherein the ring endcap is positioned on the second cylinder to form a corresponding base for the first cylinder and the second cylinder, wherein the rind endcap forms the base for the first and second cylinder when the first cylinder slides vertically along the exterior portion of the second cylinder. The system may also include a pushplate configured underneath the first cylinder and the second cylinder, wherein the pushplate rests on the ring endcap and forms a bottom portion for the first cylinder and second cylinder and enable the items to be moved out of the second cylinder.

### TECHNICAL FIELD

The present disclosure generally relates to a cylinder system. More specifically, the present invention provides a cylinder system for storing and disposing of items/trash.

### BACKGROUND

Containers that are store items such as trash often are containers with a fixed height and width. The containers cannot be adjusted to store more trash if necessary. If more trash needs to be stored, and a container already is full with trash and other items, another container has to be used to store the additional trash.

Another drawback of traditional containers is that they can only fit within certain areas of the room. In certain parts of a home, and certain rooms within a home or building, only containers of a certain height may be able to fit into certain areas of the room. Since most traditional containers have a set height, the containers typically can only fit in certain set areas of a room, and cannot be used to fit into tight spaces in the corner areas of rooms where the height of containers need to be reduced.

Another inconvenience is that a container that has to be emptied typically has to be emptied manually, wherein the container has to be lifted from its resting position, and tilted in the air to empty items. Alternatively, items can be manually removed from the container as well. Both ways of disposing of items/trash which can be cumbersome and inefficient.

Therefore, it is imperative to have a container that can have its height adjusted in a container system to enable the container and other containers to be able to store more items/trash. In addition, the height of a container should also be adjustable to enable a container to fit within any area of a room, whether an area requires more or less height for the container. Further, it is imperative that a container or container system has an efficient and less cumbersome way of disposing of items/trash.

### SUMMARY

An embodiment relates to a system comprising: A first cylinder configured to move in a vertical direction with an adjustable height and fixed diameter. The system may also include a second cylinder configured with an adjustable height and fixed diameter, wherein the second cylinder is configured with the diameter less than the diameter of the first cylinder to enable the second cylinder to be positioned within the first cylinder. In addition, the system can include one or more cushioned pads that encircle an exterior portion of the diameter of the second cylinder, wherein the one or more cushioned pads enable the first cylinder to glide vertically along the exterior portion of the second cylinder. Further, the system may include a ring endcap configured on the second cylinder, wherein the ring endcap is positioned on the second cylinder to form a corresponding base for the first cylinder and the second cylinder. The system may further include a pushplate configured underneath the first cylinder and the second cylinder, wherein the pushplate rests on the ring endcap and forms a bottom portion for the first cylinder and second cylinder and enable items to be moved out of the second cylinder.

The one or more cushioned pads provide friction to hold the first cylinder in place with the second cylinder.

The adjustable height of the first cylinder is equal to the adjustable height of the second cylinder.

The pushplate is moved in a vertical direction to move the items out of the second cylinder.

An embodiment relates to a system comprising: a first cylinder with an adjustable height and fixed diameter configured around a second cylinder with an adjustable height and a fixed diameter. The system may also include a plurality of cushioned pads configured on an exterior portion of the fixed diameter of the second cylinder, wherein the plurality of cushioned pads enable the first cylinder to adjust the height of the first cylinder and the second cylinder. Further, the system can include a ring endcap configured on a bottom portion of the second cylinder, wherein the ring endcap forms the base for the first cylinder and the second cylinder when the first cylinder and second cylinder are in a fixed or moving position. In addition, the system can include a pushplate configured on the ring endcap, wherein the pushplate is positioned on the ring endcap to form a floor for the first and second cylinder and push items within the second cylinder.

The fixed diameter of the first cylinder is greater than the fixed diameter of the second cylinder.

The plurality of cushioned pads enable the second cylinder to remain in contact with the first cylinder when the first cylinder adjusts the height of the second cylinder.

The plurality of cushioned pads encircle the exterior portion of the second cylinder to enable the second cylinder to remain in contact with the first cylinder.

The pushplate is adjusted in a vertical direction to move the items out of the second cylinder.

A method can include positioning a first cylinder with a plurality of cushioned pads in a first position. The method may also include positioning a second cylinder with a fixed diameter and adjustable height in a second position, wherein the second cylinder is in contact with the plurality of cushioned pads and encircles the first cylinder. Further, the method may include configuring a ring endcap at a position below the first cylinder, wherein the rind endcap forms a base for the first cylinder and the second cylinder. In addition, the method may include configuring a pushplate below the ring endcap, wherein the pushplate is confirmed to be in contact with the ring endcap and move in a vertical direction along the first cylinder and the second cylinder.

The second cylinder can be slid against the plurality of cushioned pads to adjust the height of the first cylinder and the second cylinder to create additional space around the first and second cylinder.

The pushplate can be moved in a vertical direction to push one or more items out of the first cylinder.

The height of the first cylinder and the second cylinder can be decreased to bring the pushplate closer to a top portion of the first cylinder.

One or more materials are wrapped around the first cylinder and the second cylinder.

Other contemplated embodiments can include objects, features, aspects, and advantages in addition to or in place of those mentioned above. These objects, features, aspects, and advantages of the embodiments will become more apparent from the following detailed description, along with the accompanying drawings.

### BRIEF DESCRIPTION OF THE FIGURES

The system of providing cylinders which can store and hold items/trash, and also dispose of the items/trash is illustrated in the figures of the accompanying drawings which are meant to be exemplary and not limiting, in which like reference numerals are intended to refer to like components, and in which:

FIG. 1 illustrates exemplary diagrams of cylinders in accordance with an embodiment of the presently disclosed embodiments;

FIGS. 2(a)-2(c) illustrates diagrams of a cylinder in accordance with an embodiment of the presently disclosed embodiments;

FIG. 3(a)-3(d) illustrates diagrams of a cylinder in accordance with an embodiment of the presently disclosed embodiments; and

FIG. 4 illustrates a flowchart describing a cylinder system to collect and dispose of trash in accordance with an embodiment of the presently disclosed embodiments.

Unless otherwise indicated illustrations in the figures are not necessarily drawn to scale.

### DETAILED DESCRIPTION OF SOME EMBODIMENTS

### Background and Context

The disclosed embodiments are best understood by reference to the Figures and detailed description herein.

Disclosed embodiments of the invention are discussed below with reference to the Figures. However, those skilled in the art will appreciate that the detailed description provided herein with respect to these figures is for explanatory purposes as the invention may extends beyond these currently disclosed embodiments. Various alternate approaches to implement the functionality of any given detail described herein is envisioned. That is, there are modifications and variations of the invention that are too numerous to be listed but that all fit within the scope of the invention. Also, singular words should be read as plural and vice-versa, where appropriate, and alternative embodiments do not imply mutual exclusivity.

It is to be further understood that the disclosed embodiments are not necessarily limited to the particular methodology, techniques, uses, and applications, described herein, as these may vary. It is also to be understood that the terminology used herein is used for the purpose of describing particular embodiments only, and is not otherwise intended to limit the scope of the present invention. It must be noted that as used herein in the detailed description and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Physical and/or conceptual structures described herein are to be understood also to refer to functional equivalents of such structures.

All words of approximation as used in the present disclosure and claims should be construed to mean “approximate,” rather than “perfect”. Words of approximation, include, yet are not limited to terms such as “substantial”, “nearly”, “almost”, “about”, “generally”, “largely”, etc.

Terms of degree are not necessarily indefinite. “Claim language employing terms of degree has long been found definite where it provided enough certainty to one of skill in the art when read in the context of the invention.” Interval Licensing LLC v. AOL, Inc., 766 F.3d 1364, 1370, 112 USPQ2d 1188, 1192-93 (Fed. Cir. 2014) (citing Eibel Process Co. v. Minnesota & Ontario Paper Co., 261 U.S. 45, 65-66 (1923. Thus, when a term of degree is used in the claim, the examiner should determine whether the specification provides some standard for measuring that degree. Hearing Components, Inc. v. Shure Inc., 600 F.3d 1357, 1367, 94 USPQ2d 1385, 1391 (Fed. Cir. 2010); Enzo Biochem, Inc., v. Applera Corp., 599 F.3d 1325, 1332, 94 USPQ2d 1321, 1326 (Fed. Cir. 2010); Seattle Box Co., Inc. v. Indus. Crating & Packing, Inc., 731 F.2d 818, 826, 221 USPQ 568, 574 (Fed. Cir. 1984).

The term “substantially” is often used in conjunction with another term to describe a particular characteristic of the claimed invention. It is a broad term. In re Nehrenberg, 280 F.2d 161, 126 USPQ 383 (CCPA 1960). The court held that the limitation “to substantially increase the efficiency of the compound as a copper extractant” was definite in view of the general guidelines contained in the specification. In re Mattison, 509 F.2d 563, 184 USPQ 484 (CCPA 1975).

All questions of enablement are evaluated against the claimed subject matter. The focus of the examination inquiry is whether everything within the scope of the claim is enabled.

Unless defined otherwise, all technical and scientific terms used herein have the same meanings as commonly understood by one of ordinary skill in the art to which the disclosed embodiments belong. Preferred methods, techniques, devices, and materials are described, although any methods, techniques, devices, or materials similar or equivalent to those described herein may be used in the practice or testing of the present invention.

Although Claims have been included in this application to specific enumerated combinations of features, it should be understood that the scope of the present disclosure also includes any novel feature or any novel combination of features disclosed herein.

References “an embodiment,” “example embodiment,” “various embodiments,” “some embodiments,” etc., may indicate that the embodiment(s) so described may include a particular feature, structure, or characteristic, but not every possible embodiment necessarily includes that particular feature, structure, or characteristic.

References to “person”, “individual”, “human”, “a party”, or any similar term, as used herein, it should be understood that such references are sole by way of example

Headings provided are for convenience and are not to be taken as limiting the present disclosure in any way.

Each term utilized herein is to be given its broadest interpretation given the context in which that term is utilized.

### Terminology

The following paragraphs provide context for terms found in the present disclosure (including the claims):

The transitional term “comprising”, which is synonymous with “including,” “containing,” or “characterized by,” is inclusive or open-ended and does not exclude additional, unrecited elements or method steps. See, e.g., Mars Inc. v. H.J. Heinz Co., 377 F.3d 1369, 1376, 71 USPQ2d 1837, 1843 (Fed. Cir. 2004) (“[L]ike the term ‘comprising,’ the terms ‘containing’ and ‘mixture’ are open-ended.”). “Configured to” or “operable for” is used to connote structure by indicating that the mechanisms/units/components include structure that performs the task or tasks during operation. “Configured to” may include adapting a manufacturing process to fabricate components that are adapted to implement or perform one or more tasks.

“Based On.” As used herein, this term is used to describe factors that affect a determination without otherwise precluding other or additional factors that may affect that determination. More particularly, such a determination may be solely “based on” those factors or based, at least in part, on those factors.

All terms of example language (e.g., including, without limitation, “such as”, “like”, “for example”, “for instance”, “similar to”, etc.) are not exclusive of other examples and therefore mean “by way of example, and not limitation . . . ”.

A description of an embodiment having components in communication with each other does not infer that all enumerated components are needed.

A commercial implementation in accordance with the scope and spirit of the present disclosure may be configured according to the needs of the particular application, whereby any function(s of the teachings related to any described embodiment of the present invention may be suitably changed by those skilled in the art.

The example embodiments described herein can be implemented in a cylinder system to store and dispose of items/trash. A plurality of cylinders can be used to implement the cylinder system.

Aspects of the present invention are described below with reference to flowchart illustrations and/or block diagrams of methods, and systems according to the disclosed embodiments. Each block of the flowchart illustrations and/or block diagrams, and combinations of blocks in the flowchart illustrations and/or block diagrams, can be implemented by various means.

The flowchart and block diagrams in the figures illustrate the architecture, functionality, and operation of possible implementations of systems and methods according to various embodiments. In this regard, each block in the flowchart or block diagrams may represent a segment which comprises one or more executable instructions for implementing the specified logical function(s). Functions noted in the block may occur out of the order noted in the figures. For example, two blocks shown in succession may, in fact, be executed substantially concurrently, or the blocks may sometimes be executed in the reverse order, depending upon the functionality involved.

Further, any sequence of steps that may be described does not necessarily indicate a condition that the steps be performed in that order. Some steps may be performed simultaneously.

The functionality and/or the features of a particular component may be alternatively embodied by one or more other devices which are not explicitly described as having such functionality/features. Also, various embodiments of the present invention need not include a device itself.

Where cylinder systems are described, it will be understood by those of ordinary skill in the art that: (i) cylinder structures alternative to those described may be implemented, (ii) other cylinder structures other than described cylinders may be implemented. Any schematic illustrations of cylinder systems and accompanying descriptions of any sample cylinder systems presented herein are example arrangements for stored representations of information. Embodiments of the invention may also be implemented in one or a combination of cylinder systems.

More specifically, as will be appreciated by one skilled in the art, aspects of the present invention may be embodied as a system and/or method. Furthermore, aspects of the present invention may take the form of a plurality of cylinder systems to store and dispose of items/trash.

Additionally, any uses of the phrase “configured to” or “operable for” can include generic structure that is manipulated to operate in a manner that is capable of performing the task(s) at issue. “Configured to” may also include adapting a manufacturing process to fabricate cylinder devices that are adapted to perform one or more tasks.

### Introduction

The present invention provides a cylinder system for storing and disposing of items/trash. Two cylinders of similar height can be placed in the same system to store and dispose of items/trash. Moreover, one cylinder can have a greater diameter than the other cylinder to enable the one cylinder to be placed around the other cylinder, and also be in contact with the other cylinder. Cushioned pads on the other cylinder can enable the one cylinder to slide vertically while being in contact with the other cylinder. The one cylinder can thereby adjust its height along the height of the other cylinder. In situations where the heights of both cylinders need to be reduced to fit into a specific area, the one cylinder can simultaneously reduce the height of both cylinders to enable both cylinders to fit into the desired area in which the height of both cylinders need to be reduced.

The cylinders can be used to store items/trash. The items/trash can be placed within the innermost cylinder with the lesser diameter among the two cylinders. Should more items/trash need to be placed within one of the cylinders, and not enough storage space is available, the height of both cylinders can be increased to create the additional space to store the additional items/trash. In addition, when the items/trash need to be removed from the cylinders, a pushplate at the bottom of the inner cylinder can be used to push the items/trash out of the inner cylinder. The pushplate can be moved vertically toward the top of the inner cylinder, and the pushplate can move the items/trash out of the inner cylinder. The pushplate may then be moved back to its original position at the bottom of the inner cylinder.

Through the cylinder system, the adjustable heights of the cylinders enable the cylinders to fit into tight areas where the heights of the cylinders need to be reduced. In addition, the adjustable heights of the cylinders can be increased to store more items/trash. In addition, the cylinders need not be moved or tilted over to empty the items/trash. A pushplate from the bottom of the inner cylinder can be moved from the bottom of the inner cylinder to the top of the inner cylinder to push out the items/trash, and then be moved back to its original position at the bottom of the inner cylinder. Accordingly, the cylinders need not be moved to empty trash, and the adjustable heights of the cylinders enable the cylinders to be able to fit in virtually any area within a room. In addition, the exterior of the cylinders be covered with wall paper or other directions to prevent the items/trash from being viewed.

### System Structure

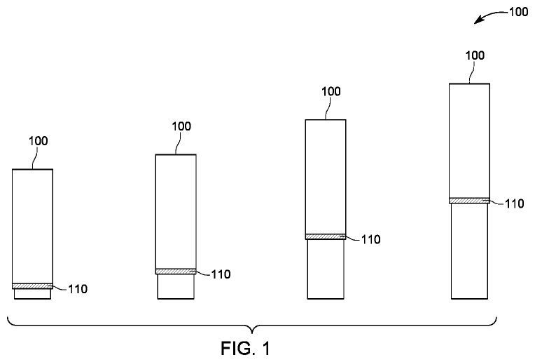

FIG. 1, illustrates a first cylinder 100, and various heights of the first cylinder. The bottom portion of the first cylinder 100 can include a guardband 110 that encircles the first cylinder 100. The guardband 110 can be made from one or more solid materials (copper, aluminium, etc.), and is not limited to any specific material. The guardband 110 can also be produced in a variety of colors such as red, yellow, blue, and green. Further, the guardband 110 may have slogans and company logos engraved on the guardband 110 as the consumer desires. The first cylinder 100 can have a fixed diameter and an adjustable height. The height of the first cylinder 100 may be adjusted vertically to create more space for storing items/trash. As shown in FIG. 1, the first cylinder 100 may either increase or reduce its height in the vertical direction.

The first cylinder 100 can be configured to receive items/trash for storage. To create additional space for storage, the first cylinder 100 can increase its height in the vertical direction. The first cylinder 100 can be moved from a top portion of the first cylinder 100 to increase the height of the first cylinder 100. Further, the first cylinder 100 can attempt to increase the space around the first cylinder 100 to store the first cylinder 100 in different places or environments. Such different places an include in a corner of room where a only a certain height of the first cylinder 100 would fit accordingly. To accommodate such a situation, the first cylinder 100 can have its height reduced as shown in FIG. 1. A top portion of the first cylinder 100 can be used to move the first cylinder 100 downward in the vertical direction.

In FIG. 1, the items/trash which may be within the first cylinder 100 can remain in the first cylinder 100 as the height of the first cylinder 100 is adjusted to either increase or decrease as illustrated in the various frames of FIG. 1. Wallpaper or the like can be wrapped around the exterior of the first cylinder 100, to prevent any items/trash within the first cylinder 100 from being seen from a front view of the first cylinder 100. As will be shown below, the first cylinder 100 may be used with one or more additional cylinders to store items and also adjust the height to either store more items or to fit the first cylinder 100 in a height restricted area.

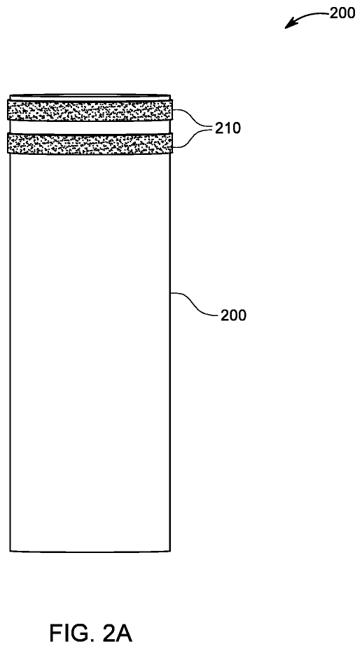

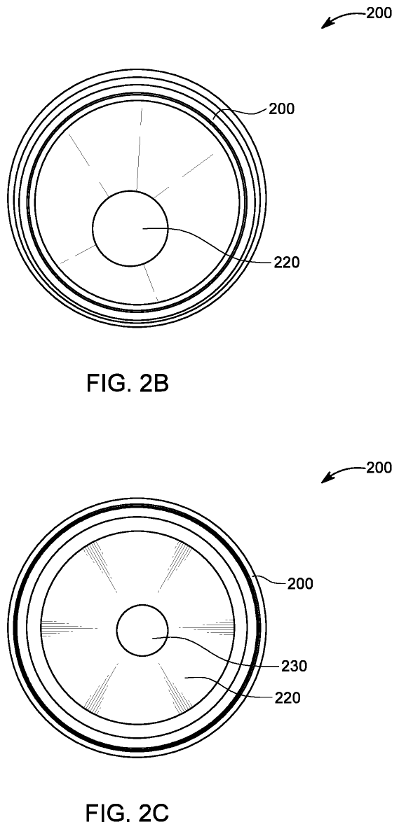

FIG. 2(a) illustrates a front view of a second cylinder 200 that can be used with one or more other cylinders to store and dispose of items/trash. The second cylinder 200 may be configured with cushioned pads 210 as shown in a front view. The cushioned pads 210 may be positioned at a top portion of the second cylinder 200. The cushioned pads 210 may also encircle the entire diameter of the second cylinder 200. The cushioned pads 210 can enable another cylinder (such as first cylinder in FIG. 1) to be placed around the second cylinder 200 and remain in contact with the second cylinder 200. The cushioned pads 210 may also enable the other cylinder to slide the second cylinder 200 vertically in either direction to enable the second cylinder 200 to store more items/trash and fit in height restricted areas. The cushioned pads 210 may provide the friction needed to enable another cylinder to slide vertically along the second cylinder 200 and remain in contact with the second cylinder 200. In addition, wallpaper or the like may be wrapped around the exterior of the second cylinder 200 to ensure that the items/trash within the second cylinder 200 are not seen from the front view of the second cylinder 200.

FIG. 2(b) illustrates a top view of the second cylinder 200. In an embodiment, the second cylinder 200 can include a ring endcap 230 (as shown in FIG. 2(c)) and a pushplate 220. The ring endcap 230 can be the base for the second cylinder 200. In addition, should the second cylinder 200 be encircled within one or more other cylinders, the ring endcap 230 may also be the base for the second cylinder 200 and the other cylinders that may be encircling the second cylinder 200. The position of the ring endcap 230 can remain constant as the height of the second cylinder 200 is adjusted. The second cylinder 200 can have its height adjusted to enable more items/trash to be stored. Further, the second cylinder 200 can adjust its height to fit in areas within a room where the height of the second cylinder 200 needs to be reduced as the first cylinder in FIG. 1. As the height of the second cylinder 200 is adjusted to either add more items to the second cylinder 200, or enable the second cylinder 200 to fit into a space that requires the second cylinder 200 to have its height reduced, the position of the ring endcap 230 remains constant at the base of the second cylinder 200. In addition, the pushplate 220 can be used to vertically push items/trash out of the second cylinder 200. The pushplate 220 can be pushed from vertically upward from the bottom of the second cylinder 200 to push items/trash out of the second cylinder 200.

FIG. 2(c) illustrates a bottom view of the second cylinder 200. In FIG. 2(c), the ring endcap 230 can be positioned on the pushplate 220. Any items/trash within the second cylinder 200 can rest on the pushplate 220. Further, as the height of the second cylinder 200 is either increased or decreased, the pushplate 220 can remain in contact with the items/trash. When the items/trash need to be taken out of the second cylinder 200, the pushplate 220 can be pushed vertically toward the top portion of the second cylinder 200. The pushplate 220 can be pushing the items/trash vertically toward the top of the second cylinder 200. As the items/trash reach at or near the top of the second cylinder 200, the pushplate 220 can push the items/trash out of the second cylinder 200. The pushplate 220 can then be adjusted to move back toward a bottom portion of the second cylinder 200 after the items/trash have been moved out of the second cylinder 200. Further, the pushplate 220 can be moved at any time to move any items/trash out of the second cylinder 200.

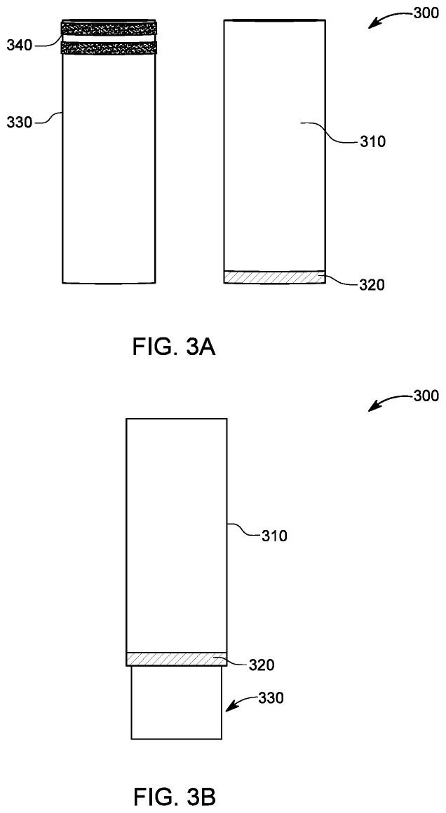

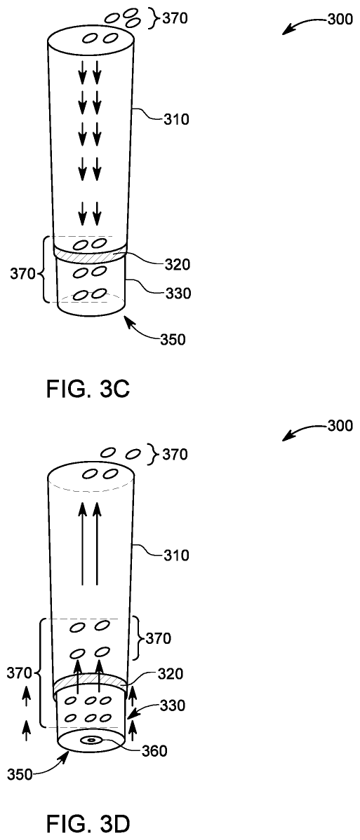

FIG. 3(a)-3(d) illustrates a cylinder system 300 involving a first cylinder 310 and a second cylinder 330. In FIG. 3(a), The first cylinder 310 may be configured with a guardband 320 at a bottom portion of the first cylinder 310. The first cylinder 310 may also be set at a first position. At a second position, a second cylinder 330 may be configured. The second cylinder 330 may be configured with cushioned pads 340 that encircle around the second cylinder 330. The cushioned pads 340 can enable the first cylinder 310 to be able to slide vertically along the second cylinder 330 when the first cylinder 310 is placed around the second cylinder 330. The cushioned pads 340 can provide the friction needed to enable the first cylinder 310 to remain in contact with the second cylinder 330, and also adjust the height of the first cylinder 310 and the second cylinder 330. The first cylinder 310 and the second cylinder 330 may both have an adjustable height. The height of both the first and second cylinder 310, 330 may be adjusted vertically to either increase or decrease in height. The diameter of the first and second cylinders 310, 330 can remain fixed. The diameter of the first cylinder 310 can be greater than the diameter of the second cylinder 330 to enable the first cylinder 310 to be able to be positioned around the second cylinder 330. Materials such as wallpaper can be wrapped entirely around the first cylinder 310 and the second cylinder 330 for aesthetic purposes.

In FIG. 3(b), the first cylinder 310 can be placed around the second cylinder 310. As the first cylinder 310 has a greater diameter than the second cylinder 310, the first cylinder 310 can be positioned to completely encircle around the diameter of the second cylinder 330. The first cylinder 310 can be affixed to completely encircle the second cylinder 330.

In FIG. 3(c), items/trash 370 may be placed into the second cylinder 330. The second cylinder 330 is part of the same cylinder system 300 as the first cylinder 310 when it receives the items/trash 370. Further additional items/trash 370 may be placed inside of the second cylinder continuously. The items/trash 370 can fall down to the pushplate 350 within the second cylinder 330. As the items/trash 370 are within the second cylinder 330, the first cylinder 310 can adjust the height of both first and second cylinder 310, 330 respectively. In an embodiment, the first and second cylinder 310, 330 may need to fit into an area where the height of the first and second cylinder 310, 330 need to be reduced. Accordingly, the first cylinder 310 may simultaneously reduce the its height along with the height of the second cylinder 330. A top portion of the first cylinder 310 may be used to reduce both the height of the first cylinder 310 and the second cylinder 330. With the reduced height of the first and second cylinder 310, 330, there is more space around the first and second cylinder 310, 330, and both the first and second cylinder 310, 330 may fit into a tight area that would not allow the first and second cylinder 310, 330 to be at their full heights respectively.

In FIG. 3(c), the first and second cylinders 310, 330 can also have their heights adjusted should more items/trash 370 need to be placed within the second cylinder 330. The top portion of the first cylinder 310 can be used to simultaneously increase the height of the first and second cylinder 310, 330 to enable more items/trash 370 to be placed within the second cylinder 330.

Referring to FIG. 3(d), when the items/trash 370 need to be moved out of the second cylinder 330, the pushplate 350, which is in contact with a ring endcap 360, can be moved in the vertical direction to push the items/trash 370 out of the second cylinder 330, and out of the two cylinder system. After the pushplate 350 moves the items/trash 370 out of the cylinder system, the pushplate 350 may be returned to its original position. The first cylinder 310 and the second cylinder 330 may continuously adjust their heights to take in more items/trash 370. In addition, the pushplate 350 can be used at any time or set time intervals to vertically move items/trash 370 out of the second cylinder 330.

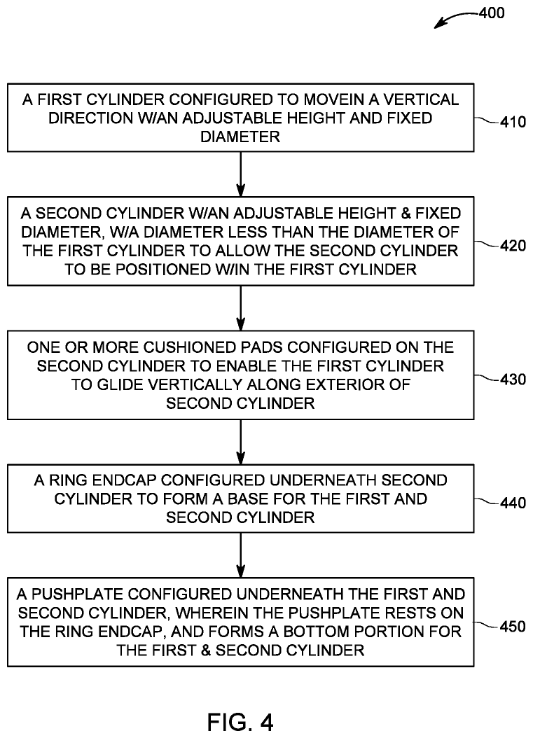

FIG. 4 describes a process 400 in which the first and second cylinders are in the same system, wherein the first cylinder can encircle the second cylinder. The first cylinder can have a greater diameter than the second cylinder, and thereby have its entire circumference encircle the second cylinder. The ring endcap can form the base for both the first and second cylinder. The pushplate can rest on the ring endcap, and also be in contact with a plurality of items/trash that have been placed within the second cylinder.

In FIG. 4, at step 410, a first cylinder is configured in a first position to move in a vertical direction. The first cylinder can have an adjustable height and a fixed diameter. The first cylinder can adjust its height to either increase or decrease its height in the vertical direction. To store more items/trash, the first cylinder can increase its height. To fit in tight spaces or increase the space around the first cylinder, the first cylinder can accordingly move its height downward to fit into one or more tight spaces or create more space around the first cylinder.

In FIG. 4, At step 420, a second cylinder can be configured within the first cylinder. The second cylinder can have an adjustable height which can be adjusted to increase, and thereby store more items/trash. The second cylinder can also have its height decreased to fit into tight areas and create more space around the second cylinder. The second cylinder may have a fixed diameter. The diameter of the second cylinder can be less than the diameter of the first cylinder to enable the first cylinder to encircle the second cylinder.

In FIG. 4, at step 430, a plurality of cushioned pads can be configured on the second cylinder. The cushioned pads can be positioned at a top portion of the second cylinder as described above in FIG. 3. The cushioned pads can encircle the entire diameter of the second cylinder at a top portion of the second cylinder. The cushioned pads can enable the first cylinder described above to maintain contact with the second cylinder. In addition, the cushioned pads can enable the first cylinder to adjust the height of the first and second cylinder without any unnecessary friction. The first cylinder can adjust the height of both the first and second cylinder without any unwanted friction when the height of both cylinders needs to be increased or decreased.

In FIG. 4, at step 440, a ring endcap can be configured on a bottom portion of the second cylinder. As the first cylinder and second cylinder are part of the same cylinder system, the ring endcap can form the base for both the first and second cylinder. The ring endcap can also remain in place when the height of the first and second cylinders is either increased or decreased. At step 450, a pushplate is configured on the ring endcap. The pushplate can also be configured on a bottom portion of the second cylinder. Items/trash can rest on the pushplate. When the items/trash need to be moved out of the second cylinder, the pushplate can be pushed vertically toward the top portion of the second cylinder. The pushplate can thereby push the items out of the second cylinder, and the system of both the first and second cylinder. The pushplate can be returned to its initial position upon pushing the items out of the system.

Those skilled in the art will appreciate that the example embodiments are non-exhaustive and that embodiments other than that described here may be included without departing from the scope and spirit of the presently disclosed embodiments.

### Advantages

Disclosed embodiments relate to methods and systems for more efficiently and effectively allowing one or ways to store items/trash within a plurality of cylinders. By incorporating the dual cylinder system with adjustable heights, more items/trash can be stored. When more items/trash need to be stored, the heights of both cylinders can be increased. The heights of the cylinders can be increased when necessary to store more items/trash.

Another advantage of the cylinder system is to be able to fit in areas of a room where the heights of the cylinder need to be reduced. The heights of the cylinders can be reduced while still storing the same amount of items/trash that may be currently in the inner cylinder among the two cylinders. In an embodiment where the heights of the cylinder need to be reduced, the height of the outer cylinder can be simultaneously reduced with the height of the inner cylinder. Accordingly, the cylinders can both fit within tight areas where both heights must be reduced to fit in such tight areas. The heights of both cylinders can be decreased whenever necessary to fit to certain tight spaces while holding the same amount of items/trash within the inner cylinder.

Yet another advantage of the two-cylinder system is being able to empty the inner cylinder of the items/trash with a false bottom. The pushplate at the bottom of the inner cylinder can be pushed vertically from the bottom of the inner cylinder to the top of the inner cylinder. The inner and outer cylinder can remain in contact while the pushplate is being moved forward. The two cylinder system does not need to disassembled or tilted forward to empty the items/trash from the inner cylinder. As a result, the cylinders can remain assembled and at the same height as the pushplate moves the items/trash out of the inner cylinder.

An additional advantage is that wallpaper and other decorative items can be placed within the cylinder system so that viewers cannot view the items/trash from a front view of the cylinders. Placing wallpaper and other decorative items on the exterior of the cylinders cannot further disguise/mask that the cylinders are being used to store and dispose of items/trash.

Accordingly, the present invention seamlessly and efficiently operates a cylinder system that can store items/trash at various heights, fit into tight areas of the room while storing the same amount of items/trash at their normal height. In addition, the cylinder system can enable items/trash to be disposed by a pushplate while allowing the cylinders to remain in place without being disassembled or tilted forward or over.

### CONCLUSION

All references, including granted patents and patent application publications, referred herein are incorporated herein by reference in their entirety.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Various aspects of the invention have been described above by way of illustration, and the specific embodiments disclosed are not intended to limit the invention to the particular forms disclosed. The particular implementation of the cylinder system provided thereof may vary depending upon the particular context or application. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

The corresponding structures, materials, acts, and equivalents of all means or step plus function elements in the claims below are intended to include any structure, material, or act for performing the function in combination with other claimed elements as specifically claimed.

What is claimed is:

1. A system comprising:
A first cylinder configured to move in a vertical direction with an adjustable height and fixed diameter;
a second cylinder configured with an adjustable height and fixed diameter, wherein the second cylinder is configured with the diameter less than the diameter of the first cylinder to enable the second cylinder to be positioned within the first cylinder;
one or more cushioned pads that encircle an exterior portion of the second diameter of the second cylinder, wherein the one or more cushioned pads enable the first cylinder to slide vertically along the exterior portion of the second cylinder;
a ring endcap configured on the second cylinder, wherein the ring endcap is positioned on the second cylinder to form a corresponding base for the first cylinder and the second cylinder, wherein the rind endcap forms the base for the first and second cylinder when the first cylinder slides vertically along the exterior portion of the second cylinder; and
a pushplate configured underneath the first cylinder and the second cylinder, wherein the pushplate rests on the ring endcap and forms a bottom portion for the first cylinder and second cylinder to enable items to be moved out of the second cylinder.

2. The system of claim 1, wherein the one or more cushioned pads provide friction to hold the first cylinder in place with the second cylinder.

3. The system of claim 1, wherein the adjustable height of the first cylinder is equal to the adjustable height of the second cylinder.

4. The system of claim 1, the cushioned pads enable the first cylinder to increase and/or decrease its height and remain in contact with the second cylinder.

5. The system of claim 1, wherein the pushplate is be moved in a vertical direction to move the items out of the second cylinder.

6. The system of claim 1, wherein the one or more cushioned pads encircle a top portion of the second cylinder.

7. The system of claim 1, wherein wallpaper is wrapped around the first cylinder and the second cylinder.

8. A system comprising:
a first cylinder with an adjustable height and fixed diameter configured around a second cylinder with an adjustable height and a fixed diameter;
a plurality of cushioned pads configured on an exterior portion of the fixed diameter of the second cylinder, wherein the plurality of cushioned pads enable the first cylinder to adjust the height of the first cylinder and the second cylinder;
a ring endcap configured on a bottom portion of the second cylinder, wherein the ring endcap forms the base for the first cylinder and the second cylinder when the first cylinder and second cylinder are in a fixed or moving position; and
a pushplate configured on the ring endcap, wherein the pushplate is positioned on the ring endcap to form a floor for the first and second cylinder and push items within the second cylinder.

9. The system of claim 8, wherein the fixed diameter of the first cylinder is greater than the fixed diameter of the second cylinder.

10. The system of claim 8, wherein the plurality of cushioned pads enable the second cylinder to remain in contact with the first cylinder when the first cylinder adjusts the height of the second cylinder.

11. The system of claim 8, wherein the plurality of cushioned pads encircle the exterior portion of the second cylinder to enable the second cylinder to remain in place with the first cylinder.

12. The system of claim 8, wherein the first cylinder adjusts the height of the second cylinder to create additional space around the first and second cylinder.

13. The system of claim 8, wherein the pushplate is adjusted in a vertical direction to move the items out of the second cylinder.

14. The system of claim 8, further comprising:
a guardband configured to encircle the first cylinder, wherein the guardband is made of one or more materials and produced in one or more colors.

15. A method comprising:
positioning a first cylinder with a plurality of cushioned pads in a first position;
positioning a second cylinder with a fixed diameter and adjustable height in a second position, wherein the second cylinder is in contact with the plurality of cushioned pads and encircles the first cylinder;
configuring a ring endcap at a position below the first cylinder, wherein the rind endcap forms a base for the first cylinder and the second cylinder; and
configuring a pushplate below the ring endcap, wherein the pushplate is confirmed to be in contact with the ring endcap and move in a vertical direction along the first cylinder and the second cylinder.

16. The method of claim 15, further comprising:
sliding the second cylinder against the plurality of cushioned pads to adjust the height of the first cylinder and the second cylinder to create additional space around the first and second cylinder.

17. The method of claim 15, further comprising:
moving the pushplate in a vertical direction to push one or more items out of the first cylinder.

18. The method of claim 15, further comprising:
decreasing the height of the first cylinder and the second cylinder to bring the pushplate closer to a top portion of the first cylinder.

19. The method of claim 15, further comprising:
configuring a guardband to encircle the second cylinder, wherein the guardband is engraved with one or more slogans and/or one or more logos.

20. The method of claim 16, further comprising:
increasing the height of the first cylinder with the height of the second cylinder to allow more items to be placed within the first cylinder.
